(19) United States
(12) Patent Application Publication
(10) Pub. No.: US 2008/0157922 A1
(43) Pub. Date: Jul. 3, 2008

(54) ELECTRONIC DEVICE WITH A HINGE

(75) Inventors: JASON M. THOMPSON, MUNDELEIN, IL (US); ROGER J. JELLICOE, WOODSTOCK, IL (US); KARL R. VOSS, SCHAUMBURG, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/616,440

(22) Filed: Dec. 27, 2006

(51) Int. Cl. G08B 5/24

(52) U.S. Cl. 340/7.63; 340/5.61

(57) ABSTRACT

A portable electronic device including first and second housing portions (102, 104) pivotally coupled to a link (402). The first and second housing portions pivot in unison relative to the link by virtue a recess of the first housing portion engaging a protrusion of the second housing portion and a protrusion of the first housing portion engaging a recess of the second housing portion when the first and second housing portions pivot relative to the link.

### FIELD OF THE DISCLOSURE

The present disclosure relates generally to portable electronic devices, and more specifically to portable electronic devices, for example, wireless communication handsets, having multi-axis hinge mechanisms.

### BACKGROUND

Portable electronic devices including mobile phones, personal digital assistants (PDAs), palmtop and laptop computers, have become indispensable among the increasingly mobile sector of the population. Some portable electronic devices, for example, clam-shell style devices, have first and second housing portions pivotally interconnected by a hinge. Other devices include hinged housing portions or panels. In some hinged devices, the housing portions are interconnected by a pivotal link, wherein two housing portions are pivotally coupled to the link about corresponding axes. In one known link hinge mechanism, the movement of the housing portions is controlled by a relatively complex gear drive located within the hinge mechanism.

The various aspects, features and advantages of the disclosure will become more fully apparent to those with ordinary skill in the art, on careful consideration of the following Detailed Description and the accompanying drawings. The drawings have been simplified for clarity and are not necessarily drawn to scale.

### BRIEF DESCRIPTION OF THE FIGURES

FIG. 1 illustrates a portable electronic device having hinged housing portions.

FIG. 2 illustrates a first housing portion of an electronic device.

FIG. 3 illustrates a second housing portion of an electronic device.

FIG. 4 illustrates a hinged electronic device in a closed position.

FIG. 5 illustrates a front view and a side view of an electronic device in a semi open position.

FIG. 6 illustrates a fixed separation between a first pivot axis and a second pivot axis of an electronic device.

### DETAILED DESCRIPTION

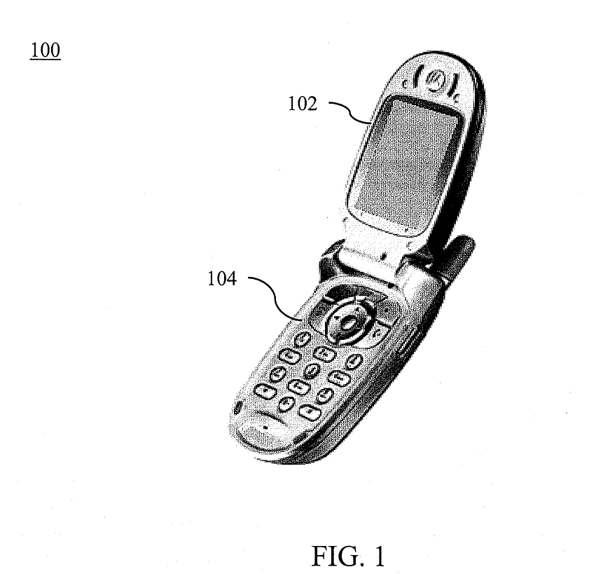

FIG. 1 illustrates a portable electronic device 100 in the form of a wireless communication handset. Though the electronic device 100 is shown as a clam-shell mobile communication handset, it could be implemented as some other portable electronic device, for example, a laptop, a personal digital assistant, and the like. The electronic device comprises a first housing portion 102 and a second housing portion 104. The first housing portion 102 is a first body part of the electronic device and can include electronic components such as a display screen, a speaker of the mobile phone, and the like. The second housing portion 104 is a second body part of the electronic device and can include components of the electronic device such as a keypad for giving inputs to the electronic device, a microphone, and the like. More generally, the housing portions may include other components, for example, a processor and memory, wireless transceiver, among other components.

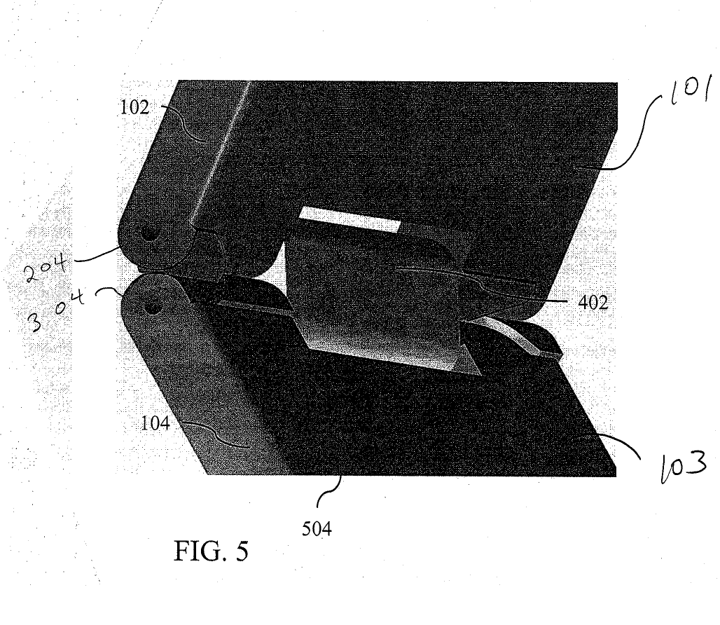

In FIG. 1, the first and second housing portions rotate or pivot about an axis. In FIG. 5, alternatively, the first and second housing portions 102 and 104 are interconnected by a hinge mechanism 402 wherein the first and second housing portions pivot about corresponding first and second pivot axes, respectively, as discussed more fully below.

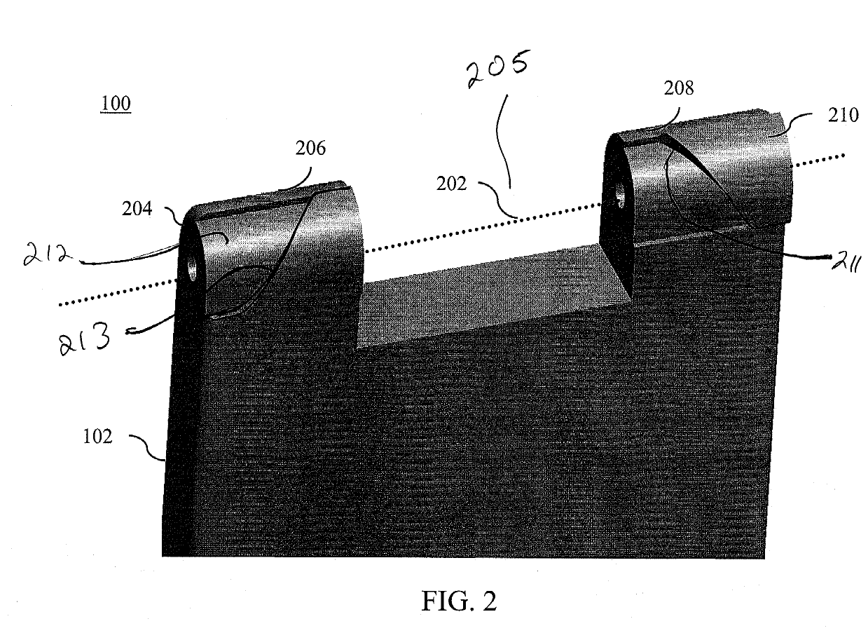

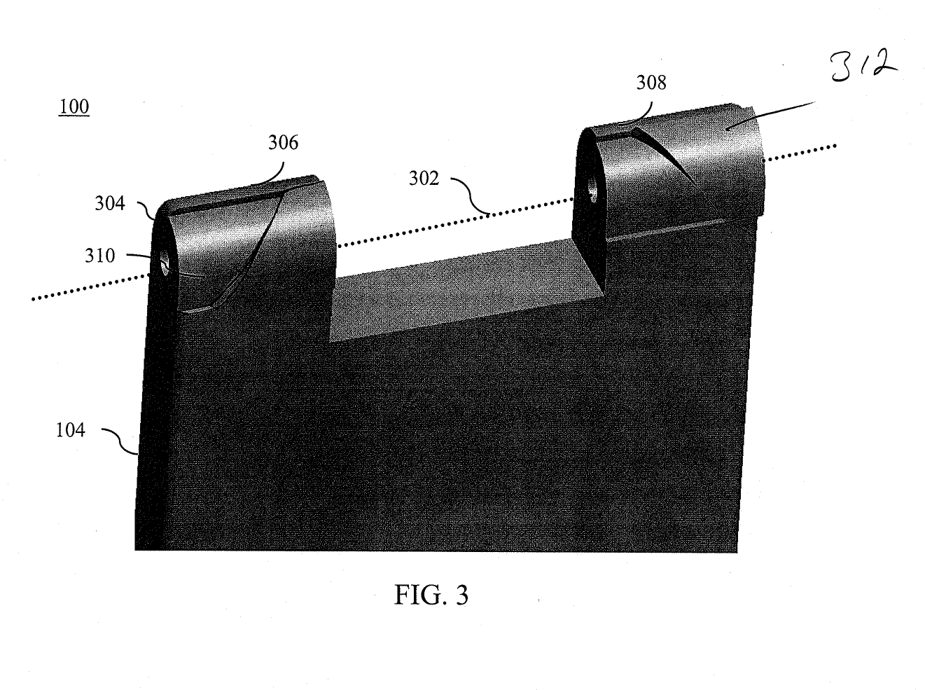

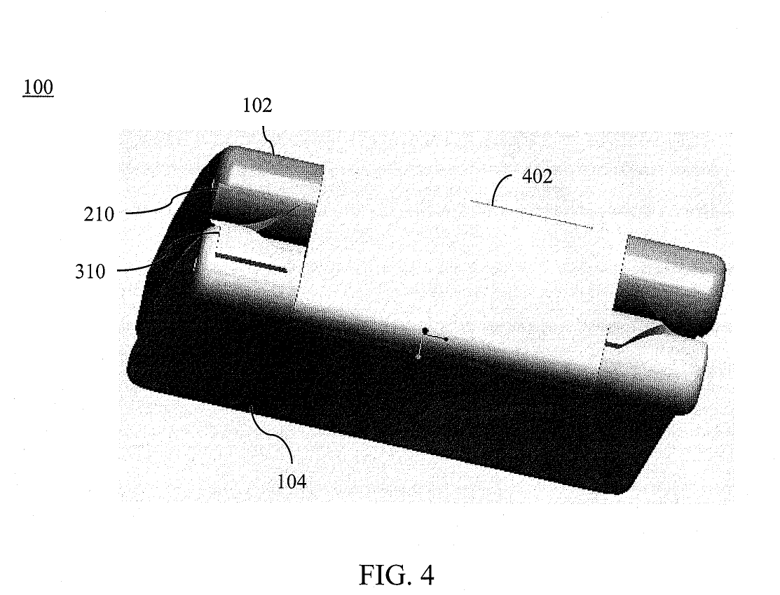

FIG. 2 illustrates the first housing portion 102 of the assembly of FIG. 4. In FIG. 2, the first housing portion 102 is shown to have a first pivot axis 202 about which the first housing portion is coupled to the hinge mechanism (not shown in FIG. 2). The first housing portion 102 includes a first curved end portion 204 having recess 205 for accommodating a portion of the hinge mechanism. The recess 205 separates a first curved end portion 206 and a second curved end portion 208 on the end portion 204. In FIG. 3, the second housing portion 104 includes a second curved end portion 304 having recess 305 for accommodating a portion of the hinge mechanism. The recess 305 separates a first curved end portion 306 and a second curved end portion 308 on the end portion 304.

In FIG. 5, when the first and second housing portions 102 and 104 are interconnected by the hinge portion 402, the housing portions are pivotal about corresponding pivot axes between closed and opened configurations. FIG. 5 illustrates the housing portions in an opened or at least partially opened configuration. The housing portions are in the closed configuration when surfaces 101 and 103 of the first and second housing portions are adjacent each other in a substantially mating relationship as illustrated in FIG. 4. FIG. 5 also illustrates the curved end portions 204 and 304 of the first and second housing portions cooperatively interacting as the housing portions pivot about the corresponding axes as discussed further below.

In FIG. 2, the first housing portion includes a protruding engagement portion 210 on the curved end portion thereof. The protruding engagement portion includes a surface, for example, the curved edge 211, non-parallel to the first pivot axis 202. The first housing portion also includes a recessed engagement portion 212 on the curved end portion thereof. The recessed engagement portion includes a surface, for example, the curved edge 213, non-parallel to the first pivot axis 202. In FIG. 3, the second housing portion also includes a recessed portion 310 and a protruding portion 312 on the curved end portion thereof. The recess of the first housing portion and the protrusion of the second housing portion having complementary configurations, and the protrusion of the first housing portion and the recess of the second housing portion having complementary configurations.

In FIG. 2, the curved surface or edge 211 is at an angle (measured counter clockwise from the pivot axis) greater than 90 degrees but less then 180 degrees relative to the pivot axis 202. The curved surface or edge 213 is at an angle less than 90 degrees but greater than 0 degrees relative to the pivot axis 202.

FIG. 5 illustrates the recess of the first housing portion engaging a complementary shaped portion of the protrusion of the second housing portion and the protrusion of the first housing portion engaging a complementary shaped portion of the recess of the second housing portion when the first and second housing portions pivot about their respective axes relative to the link.

In FIG. 5, the protruding engagement portion 210 of the first housing portion 102 engages the recessed engagement portion 310 of the second housing portion 104 while the electronic device is opening. Engagement between the complementary shaped protruding and recessed portions of the first and second housing portions causes the housing portions to pivot in unison relative to the hinge portion. Particularly, pivoting the first housing portion about the pivot axis relative to the link causes the second housing portion to pivot about its pivot axis relative to the link. Thus when one of the first or second housing portions is pivoted from the opened configuration to the closed configuration, the other housing portion is also pivoted from the opened configuration to the closed configuration. Similarly when one of the first or second housing portions is pivoted from the closed configuration to the opened configuration, the other housing portion is also pivoted from the closed configuration to the opened configuration. The synchronous pivoting of the first and second housing portions relative to the hinge mechanism results from the engaging interaction of the complementarily configured protrusions and recesses on the end portions of the housing portions.

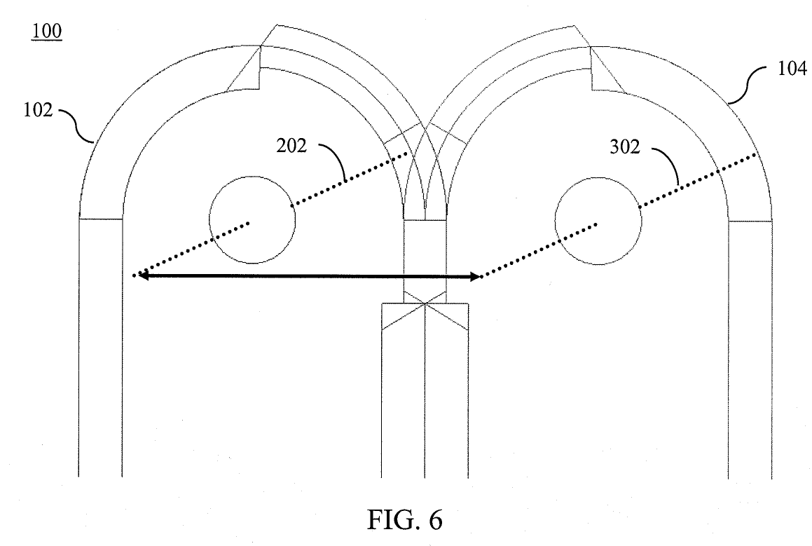

FIG. 6 illustrates the fixed separation between the first pivot axis 210 and the second pivot axis 310 of the electronic device 100. During pivoting of the first and second housing portions, the first pivot axis 202 remains at a position of fixed separation from the second pivot axis 302. The fixed separation ensures cooperative engagement of the recesses and protruding portions of the housing portions.

In one implementation, the protruding and recessed engagement portions and the curved edges thereof extend from one side of the housing portion to the other, opposite side thereof. Thus configured, the first and second housing portions are capable of synchronized pivoting of substantially 360 degrees.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. An electronic device comprising:
a first housing portion having a first end portion;
a second housing portion having a second end portion;
a link interconnecting the first and second housing portions, the link pivotally coupled to the first end portion of the first housing portion about a first pivot axis, the link pivotally coupled to the second end portion of the second housing portion about a second pivot axis;
a protruding engagement portion on the first end portion of the first housing portion, the protruding engagement portion including a surface non-parallel to the first pivot axis;
a recessed engagement portion on the second end portion of the second housing portion, the recessed engagement portion including a surface non-parallel to the second pivot axis;
the protruding engagement portion engaging the recessed engagement portion when the first and second housing portions pivot relative to the link.

2. The device of claim 1, the protruding engagement portion engaging the recessed engagement portion over a full pivotal range of the first and second housing portions between opened and closed configurations.

3. The device of claim 1,
the link pivotally coupled to the first end portion of the first housing between first and second curved end portions of the first housing portion,
the link pivotally coupled to the second end portion of the second housing between first and second curved end portions of the second housing portion.

4. The device of claim 3,
the protruding engagement portion on the first curved end portion of the first housing portion,
a recessed engagement portion on the second curved end portion of the first housing portion, the recessed engagement portion including a surface non-parallel to the first pivot axis;
the recessed engagement portion on the first curved end portion of the second housing portion,
a protruding engagement portion on the second curved end portion of the second housing portion, the protruding engagement portion including a surface non-parallel to the second pivot axis;
the recessed engagement portion of the first housing portion engaging the protruding engagement portion of the second housing portion when the first and second housing portions pivot relative to the link.

5. The device of claim 1, the protruding engagement portion slides into the recessed engagement portion when the first and second housing portions pivot away from each other.

6. The device of claim 1, the protruding engagement portion slides out of the recessed engagement portion when the first and second housing portions pivot toward each other.

7. The device of claim 1,
a recessed engagement portion on the first end portion of the first housing portion, the recessed engagement portion including a surface non-parallel to the first pivot axis;
a protruding engagement portion on the second end portion of the second housing portion, the protruding engagement portion including a surface non-parallel to the second pivot axis.

8. The device of claim 7, the protruding engagement portions engaging the recessed engagement portions when the first and second housing portions pivot relative to the link.

9. The device of claim 8, the first and second pivot axes having a fixed separation resulting from the protruding engagement surfaces engaging the recessed engagement surfaces when the first and second housing portions pivot relative to the link.

10. The device of claim 8, the first and second housing portion laterally constrained by the protruding engagement surfaces engaged with the recessed engagement surfaces when the first and second housing portions pivot relative to the link.

11. The device of claim 1, the first pivot axis parallel to the second pivot axis.

12. The device of claim 1, the recessed engagement surface and the protruding engagement surface having complementary configurations.

13. A portable electronic device comprising:
a first housing portion having a first end portion;
a second housing portion having a second end portion;
a link interconnecting the first and second housing portions, the link pivotally coupled to the first end portion of the first housing portion about a first pivot axis, the link pivotally coupled to the second end portion of the second housing portion about a second pivot axis,
a protrusion having an edge on the first end portion of the first housing portion, a recess having an edge on the first end portion of the first housing portion,
a recess having an edge on the second end portion of the second housing portion, a protrusion having an edge on the second end portion of the second housing portion,
the recess of the first housing portion and the protrusion of the second housing portion having complementary configurations, and the protrusion of the first housing portion and the recess of the second housing portion having complementary configurations,
the recess of the first housing portion engages the protrusion of the second housing portion and the protrusion of the first housing portion engages the recess of the second housing portion when the first and second housing portions pivot relative to the link,
wherein the first and second housing portions pivot unison relative to the link by virtue of the engagement of the protrusion and recess portions.

14. The device of claim 13 is a wireless communication device.

15. The device of claim 13, the first and second pivot axes of the link are separated by a fixed distance.

16. The device of claim 13, the edges of the protrusions and the edges of the recesses are oriented non-parallel to the first and second pivot axes.

17. The device of claim 13, the protrusion and recesses are formed on curved end portions of the first and second housing portions.

18. The device of claim 13, the recess of the first housing portion engages the protrusion of the second housing portion and the protrusion of the first housing portion engages the recess of the second housing portion when the first and second housing portions pivot relative to the link
